(19) United States
(12) Patent Application Publication
(10) Pub. No.: US 2002/0186948 A1
(43) Pub. Date: Dec. 12, 2002

(54) Electro-optic waveguide structure

(76) Inventors: Michael Bazylenko, Eveleigh (AU); Ian Kenneth Mann, Eveleigh (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/880,517

(22) Filed: Jun. 12, 2001

(51) Int. Cl. G02B 6/10

(52) U.S. Cl. 385/131; 385/129

(57) ABSTRACT

The invention concerns a method of forming a thin film electro-optic waveguide. In one embodiment, the method comprises forming a platinum film on a substrate, forming a PLZT film on the platinum film, and forming a PZT film on the PLZT film. The PLZT film has a lower refractive index than the PZT film. The PZT film functions as a waveguide core and the PLZT film functions as an optical buffer layer for optically isolating the PZT film from the platinum film. When the structure is thermally processed, the platinum film promotes the crystallinity in the PLZT film, which in turn promotes crystallinity in the PZT film. The invention is particularly useful for integrating non-silica-based electro-optic materials with silica-based waveguide structures. The invention also concerns an optical waveguide device formed by the method.

### TECHNICAL FIELD

The present invention relates broadly to a method of fabricating an electro-optic waveguide structure on a substrate, and to an electro-optic waveguide structure.

### BACKGROUND OF THE INVENTION

Electro-optic waveguide structures are utilised in a large number of optical components, such as in electro-optic phase modulators based on bulk-form lanthanum-containing lead zirconate titanate (PLZT) or lead zirconate titanate (PZT). Such modulators use the fact that the refractive index of an electro-optic material, and thus the phase of an optical signal passing through the electro-optical material, can be changed by exposing the electro-optic material to an electric field.

PZT and PLZT have very high electro-optic coefficients, i.e. a large refractive index change can be induced at a given electric field strength when compared with low electro-optic coefficient materials, which make them particularly attractive for use in such phase modulators,

In the area of optical communications, there is further a need to provide electro-optic waveguide structures such as electro-optic phase modulators which can be monolithically integrated with other optical components on a single substrate structure. Since bulk-form modulators are not readily integratable with other optical components such as waveguides having dimensions of the order of 1 to 10 microns, thin film modulators of comparable dimensions are required which can be integrated with silica-based thin film waveguide structures.

PLZT and PZT can be produced in thin-film form by a range of deposition methods, including sputtering, sol-gel processing, and laser ablation. Unfortunately, it has been found that when PLZT and PZT films are grown on an amorphous layer, such as amorphous silica, amorphous PLZT and PZT films are produced which exhibit little or no electro-optic effect. In order to produce poly-crystalline PLZT or PZT films, it has been found necessary to deposit the PLZT or PZT film on a “seed” layer which promotes crystalline growth. Post-deposition annealing may be required to facilitate the promotion of crystallinity in the PLZT or PZT films formed on a seed layer.

Platinum thin films have been used as seed layers for the formation of crystalline PLZT or PZT films. Platinum thin films are known to self-orient in the (111) direction. For example, PLZT and PZT thin films deposited on platinum have been used as ferromagnetic layers in ferroelectric random access memory (FRAM) devices. In FRAMs, each ferroelectric layer is used as a capacitor and the platinum seed layer has the added advantage of functioning as an electrode.

However, in the case of optical waveguide devices, the electrical conductivity of platinum causes severe optical attenuation of any optical signal propagating in an adjacent electro-optic thin film. This makes prior art methods of forming crystalline electro-optic waveguide structures on light-absorbing seed layers not suitable for the formation of optical waveguide devices.

The present invention seeks to provide an alternative method of fabricating electro-optic waveguide structures which can be integrated, if necessary, with silica-based optical components on a single substrate structure.

### SUMMARY OF THE INVENTION

Throughout the specification the term “crystallinity” is intended to include polycrystalline and single-crystal phases.

Throughout the specification the term “buffer layer” is intended to refer to an optically-isolating layer.

In accordance with a first aspect of the present invention there is provided a method of fabricating an electro-optic waveguide structure on a substrate, the method comprising the steps of forming an intermediate layer on the substrate, and forming a crystalline electro-optic waveguide core layer on the intermediate layer, wherein the intermediate layer is arranged to promote the growth of a crystalline phase in the electro-optic waveguide core layer and to function as an optically-transparent buffer layer for optically isolating the electro-optic waveguide core layer.

The intermediate layer may initiate and/or enhance the growth of the crystalline phase. The intermediate layer may comprise one or more layers.

The step of forming the core layer may comprise depositing the core layer and thermally processing the deposited core layer in a manner which facilitates the formation of a polycrystalline microstructure in the core layer. The step of thermally processing the core layer may comprise annealing the core layer post-deposition and/or heating the core layer in situ during the deposition. Preferably, the polycrystalline microstructure has a preferred grain orientation, and may be epitaxial.

In one embodiment, the step of forming the intermediate layer comprises forming an optically-transmissive buffer layer on the substrate, wherein the buffer layer is arranged to promote the growth of a crystalline phase in the electro-optic waveguide core layer.

In another embodiment, the step of forming the intermediate layer comprises forming a seed layer on the substrate and forming an optically-transmissive buffer layer on the seed layer, wherein the seed layer is arranged to promote the growth of a crystalline phase in the buffer layer, and the buffer layer is arranged to promote the growth of a crystalline phase in the electro-optic waveguide core layer. The seed layer may be optically absorbing.

In another embodiment, the step of forming the intermediate layer comprises forming an optically-transmissive buffer layer on the substrate, and forming an optically-transmissive seed layer on the buffer layer, wherein the seed layer is arranged to promote the growth of a crystalline phase in the electro-optic waveguide core layer.

The substrate may have a surface which is substantially amorphous and may be optically absorbing. The substrate may comprise a wafer of silicon, and may further comprise one or more overlayers, such as a silica film and/or a metal film, on which the intermediate layer is formed. In one embodiment, the substrate is a multilayer structure comprising a film of titanium formed on a film of silica which is in turn formed on a silicon wafer.

The optically-transmissive seed layer may comprise a ferroelectric material such as PLZT.

The optically-transmissive seed layer may comprise at least one type of metal oxide such as ZnO.

The electro-optic waveguide core layer may comprise a ferroelectric material such as PZT or PLZT.

The method may further comprise a step of shaping the electro-optic waveguide core layer into a channel waveguide geometry, for example by using photolithographically-defined etching.

The method may further comprise a step of forming an upper optically-transmissive cladding layer on the electro-optic waveguide core layer for optically isolating an upper face of the waveguide core layer. For example, the upper cladding layer may comprise a silica-based layer. At least one electrode may be formed on the upper cladding layer.

The electro-optic waveguide core layer and/or the intermediate layer may be formed by sputtering. The sputtering may comprise either RF or DC sputtering, depending on the material used.

The core and intermediate layers may be formed such that there is a graded refractive index transition from the intermediate layer to the core layer. The core and intermediate layer may each have a refractive index which is graded across its thickness. The core and at least a buffer layer within the intermediate layer may be based on the same material, but have different refractive indices defined by compositional differences of the material. For example, the core and buffer layer may comprise layers of PLZT which have sufficiently different ratios of lanthanum and zirconium to give the core a higher refractive index than the buffer layer.

In accordance with a second aspect of the present invention there is provided an electro-optic waveguide structure comprising an intermediate layer formed on a substrate, and a crystalline electro-optic waveguide core layer formed on the intermediate layer, wherein the intermediate layer is arranged to promote the growth of a crystalline phase in the electro-optic waveguide core layer during fabrication of the waveguide structure, and, in use, to function as an optically-transmissive buffer layer for optically isolating the core layer.

The electro-optic waveguide core layer may be polycrystalline and may have a preferred grain orientation.

In accordance with a third aspect of the present invention there is provided an optical waveguide device incorporating a waveguide structure as described in the second aspect of the invention.

The device may be in the form of one or more of the following: an optical modulator; an optical coupler for coupling an optical light signal between the electro-optic waveguide core structure and a further waveguide; and a Mach-Zehnder interferometer.

### BRIEF DESCRIPTION OF THE DRAWINGS

Embodiments of the present invention will now be described, by way of example only, with reference to the accompanying drawings.

FIGS. 1A-C are schematic drawings illustrating a fabrication process embodying the present invention.

FIGS. 2A-C are schematic drawings illustrating another fabrication process embodying the present invention.

FIGS. 3A and B are schematic drawings illustrating another process embodying the present invention.

FIG. 4 is a schematic drawing of a device manufactured utilising a fabrication process embodying the present invention.

FIG. 5 is a schematic drawing showing another device fabricated utilising a fabrication process embodying the present invention.

### DETAILED DESCRIPTION OF THE DRAWINGS

The embodiments described below provide electro-optic planar waveguide structures suitable for monolithic integration with other optical components, such as silica-based waveguides, on a single substrate. In each embodiment, an intermediate layer is included which serves the dual functions of: (a) optically isolating a waveguide core layer from an optically-absorbing material; and (b) promoting the growth of a crystalline phase in the waveguide core layer. In some embodiments, the intermediate layer comprises a single layer of material, while in other embodiments the intermediate layer comprises a mutilayered structure in the form of a buffer layer and a seed layer.

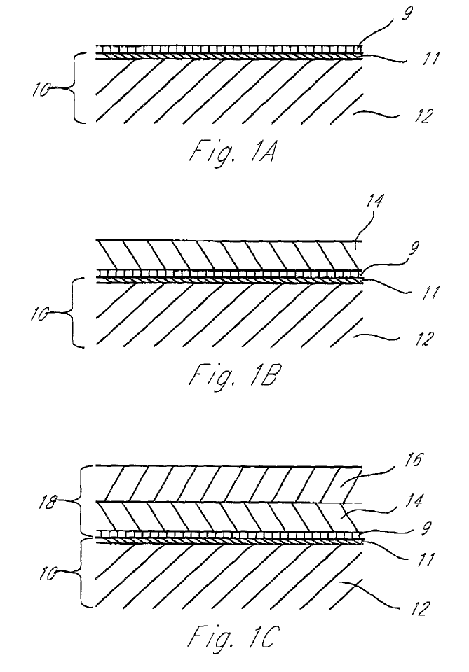

A first embodiment of a process for fabricating an electro-optic waveguide structure fabrication process will now be described with reference to FIGS. 1A-C.

As a first step (FIG. 1A), a seed layer in the form of a 200-nm-thick self-orienting platinum film 9 is deposited on a substrate 10, which in this case comprises a film of titanium 11 (20 nm thick) formed on a 15-μm-thick film of amorphous silica 12, which is in turn be formed on a silicon wafer (not shown). The titanium film 11 improves the adhesion of the platinum film 9 to the silica film 12.

In a second step, shown in FIG. 1B, an optically-transmissive buffer layer in the form of a PLZT film 14 (2.5-μm-thick) is deposited on the platinum film 9 The composition of the PLZT film 14 is 9/65/35 i.e. the Pb/La ratio is 91%/9% and the Zr/Ti ratio is 65%/35%, In this embodiment, the platinum film 9 and buffer layer 14 together comprise the intermediate layer.

In a further deposition step, shown in FIG. 1C, an electro-optic waveguide core layer in the form of a PZT film 16 (Pb(Zr₅₃Ti₄₇)O₃, 2.0-μm-thick) is deposited on the PLZT film 14. The resulting electro-optic waveguide structure 18 is then subjected to a post-deposition annealing process (60° C. for 30 mins. in air). It is believed that during the annealing process the platinum layer 19 functions as a seed layer for nucleating and/or enhancing the growth of a crystalline phase in the PLOT film 14, which in turn functions as a seed layer for nucleating and/or enhancing growth of a crystalline phase in the PZT film 16.

The PLZT buffer film 14 allows an optical signal to be guided in the PZT film without experiencing the severe optical attenuation that would occur if the PZT film was formed directly on the platinum seed layer.

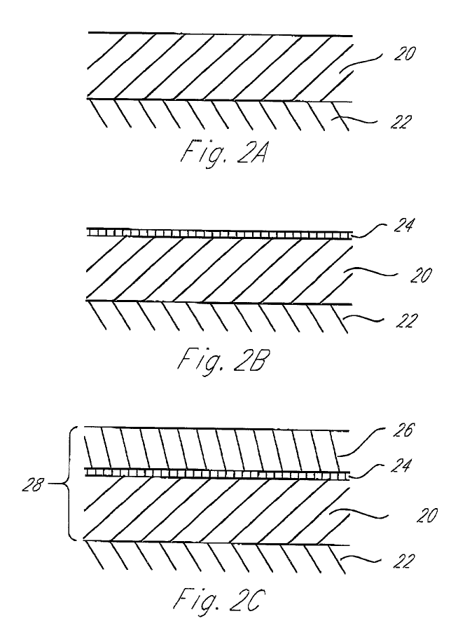

Another embodiment of a process for fabricating an electro-optic waveguide structure will now be described with reference to FIGS. 2A-C. As a first step (FIG. 2A) an optically-transmissive buffer layer in the form of an amorphous silicon dioxide film 20 is deposited on a substrate 22 which, in this case, comprises a wafer of silicon. The amorphous silicon dioxide film 20 is approximately 15 μm thick and can be deposited by thermal oxidation of the silicon substrate or by plasma-enhanced chemical vapour deposition (PECVD).

In a second step, shown in FIG. 2B, an optically-transmissive seed layer in the form of a zinc oxide (ZnO) film 24 (0.3 μm thick) is deposited on the silicon dioxide film 20. The as-deposited zinc oxide film 24 is polycrystalline with a preferred (0001) orientation. In this embodiment, the silica film 20 and zinc oxide film 24 together comprise the intermediate layer.

In a further deposition step, shown in FIG. 2C, an electro-optic waveguide core layer in the form of a PLZT film 26 (2.0 μm thick) is deposited on the zinc oxide seed layer 24. The resulting electro-optic waveguide structure 28 is then subjected to a post deposition annealing process (60° C. for 30 mins. in air). During the annealing process, the zinc oxide film 24 nucleates and/or enhances the growth of a crystalline phase in the PLZT film 26. The zinc oxide film 24 and the silicon oxide film 20 both have lower refractive indices than the PLZT film 26. Thus, the intermediate layer (the zinc oxide film 24 and silica film 20) has a lower average refractive index than the PLZT film 26 and optically isolates the PLZT film from the silicon substrate 22. Although the optically-transmissive seed layer 24 in this embodiment comprises a film of zinc oxide, it will be understood by a person skilled in the art that the optically-transmissive seed layer 24 could alternatively comprise any other material which is optically-transmissive and is capable of seeding crystallinity in the electro-optic core layer 26. For example, the zinc oxide film 24 could be replaced with a film of aluminium oxide or indium tin oxide (ITO). The optically-transmissive seed layer 24 could also incorporate one or more dopants for modifying physical properties such as refractive index.

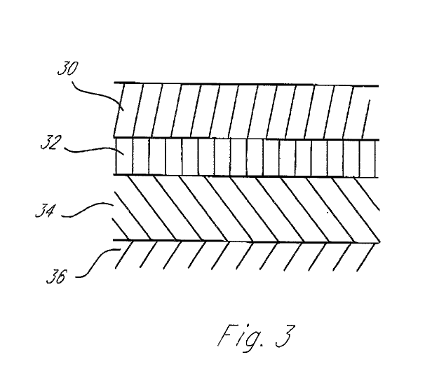

Referring to FIG. 3 there is shown a variation on the embodiment shown in FIG. 2C. The embodiment shown in FIG. 3 comprises a 2.0-μm-thick PLZT film 30 formed directly on a 2.5-μm-thick zinc oxide film 32, which is in turn formed on a 15 μm thick silicon dioxide film 34. As with the previous embodiment, the entire waveguide structure is supported on a silicon wafer 36. However, unlike the previous embodiment, the zinc oxide film 32 in FIG. 3 is sufficiently thick (2.5 μm) to function as both as a seed layer and an optical buffer layer. Thus, the intermediate layer in this embodiment consists of zinc oxide film 32 and the substrate consists of the silicon wafer 36 and silica film 34. The silicon dioxide film 34 in this waveguide is not used as a buffer layer since the zinc oxide film 32 serves this function. However, the silica film 34 can be useful as an electrical isolation layer for reducing the flow of charge carriers in the PLZT film 30 when a voltage is applied across its thickness.

In each of the above embodiments, the intermediate layer can be annealed prior to the deposition of the core layer. In that case, the entire waveguide structure can be annealed again once the core layer has been deposited on the intermediate layer. Alternatively, the waveguide structure may be annealed in a single annealing process after all of the layers of the waveguide structure has been deposited. A further alternative is to heat the substrate in situ during the deposition of the core and intermediate layers.

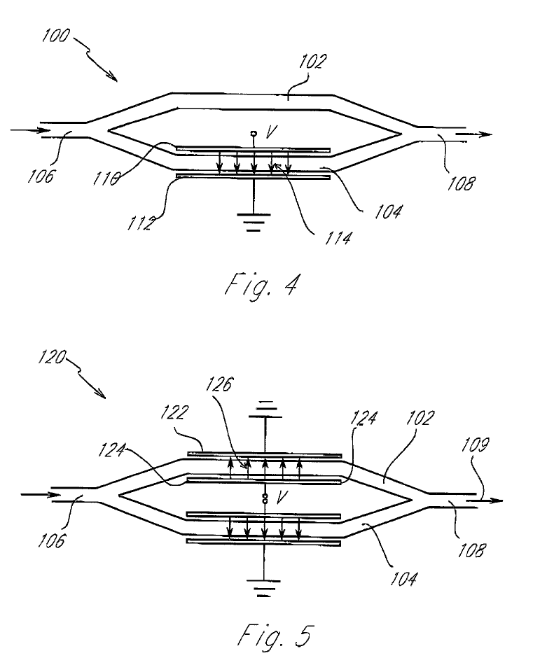

Turning now to FIG. 4, an example electro-optic device 100 fabricated in accordance with an embodiment of the present invention will now be described.

The device 100 is a Mach-Zehnder interferometer comprising two optical waveguide arms 102, 104 formed in parallel between an optical input waveguide portion 106 and an optical waveguide output portion 108.

In the device 100 shown in FIG. 4, waveguide arms 102 and 104 and the waveguide portions 106, 108 include integral polycrystalline PLZT cores formed in accordance with one of the fabrication processes described above with reference to FIGS. 1 to 3. It will be appreciated by the person skilled in the art that suitable masking and/or etching techniques are employed to form the waveguide arms 102, 104 and waveguide portions 106 and 108.

Thin film electrodes 110, 112 are provided in the device 100 to expose a retard arm 104 to an electric field 114. By controlling the magnitude of the electric field 114, a phase shift between light propagating in the retard arm 104 and light propagating in the other waveguide arm 102 can be controlled. The light signals of both arms 104, 102 interfere at the optical output waveguide portion 108, with the intensity of the optical output signal varying as a result of the controlled phase difference.

In FIG. 5, an alternative Mach Zehnder interferometer device 120 is similar to the previous embodiment 100, but further comprises an additional pair of electrodes 122, 124 arranged to apply an electric field 126 across the other optical waveguide arm 102. In this alternative embodiment, the electric fields 114, 126 have opposite directions between the arms 102 and 104, to control the phase difference between light signals travelling in the respective arms 102, 104 in a push-pull-type configuration. Again, the light signals propagating in the respective arms 102, 104 interfere at the optical waveguide output portion 108, and the intensity of the optical output signal 109 can thus be controlled/modulated.

It will be understood that the core layer can comprise any optically-transmissive electro-optic material which requires a seed layer in order to promote the growth of a crystalline phase in the core layer. For example, the core layer could alternatively comprise, but is not limited to, PLT (lead lanthanum titanate) or lithium niobate.

It will be appreciated by the person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

In the claims that follow and in the summary of the invention, except where the context requires otherwise due to express language or necessary implication, the word “comprising” is used in the sense of “including” i.e. the features specified may be associated with further features in various embodiments of the invention.

1. A method of fabricating an electro-optic waveguide structure on a substrate, the method comprising the steps of:
forming an intermediate layer on the substrate, and
forming a crystalline electro-optic waveguide core layer on the intermediate layer,
wherein the intermediate layer is arranged to promote the growth of a crystalline phase in the electro-optic waveguide core layer and to function as an optically-transparent buffer for optically isolating the electro-optic waveguide core layer.

2. A method as claimed in claim 1, wherein the step of forming the crystalline core layer further comprises thermally processing the core layer in a manner which facilitates the formation of a crystalline phase in the core layer.

3. A method as claimed in claim 1, wherein the step of forming the intermediate layer comprises forming an optically-transmissive buffer layer on the substrate layer, wherein the buffer layer is arranged to promote the growth of a crystalline phase in the electro-optic waveguide core layer.

4. A method as claimed in claim 1, wherein the step of forming the intermediate layer comprises forming a seed layer on the substrate and forming an optically-transmissive buffer layer on the seed layer, wherein the seed layer is arranged to promote the growth of a crystalline phase in the buffer layer, and the buffer layer is arranged to promote the growth of a crystalline phase in the electro-optic waveguide core layer and to optically isolate the core layer.

5. A method as claimed in claim 1, wherein the step of forming the intermediate layer comprises forming an optically-transmissive buffer layer on the substrate, and forming an optically-transmissive seed layer on the buffer layer, wherein the seed layer is arranged to promote the growth of a crystalline phase in the electro-optic waveguide core layer and the buffer layer is arranged to optically isolate the core layer.

6. A method as claimed in claim 1, wherein the substrate has a surface which is substantially amorphous.

7. A method as claimed in claim 1, wherein the optically-transmissive seed layer comprises a ferroelectric material.

8. A method as claimed in claim 1, wherein the optically-transmissive seed layer substantially comprises PLZT.

9. A method as claimed in claim 1, wherein the optically-transmissive seed layer comprises at least one type of metal oxide.

10. A method as claimed in claim 1, wherein the optically-transmissive seed layer substantially comprises ZnO.

11. A method as claimed in claim 1, wherein the electro-optic waveguide core layer comprises a ferroelectric material.

12. A method as claimed in claim 1, wherein the electro-optic waveguide core layer comprises PZT or PLZT.

13. A method as claimed in claim 1, wherein the method further comprises a step of shaping the electro-optic waveguide core layer into a channel waveguide geometry.

14. A method as claimed in claim 1, wherein the method further comprises a step of forming an upper optically-transmissive cladding layer on the electro-optic waveguide core layer for optically isolating an upper face of the waveguide core layer.

15. A method as claimed in claim 14, wherein at least one electrode is formed on the upper cladding layer.

16. A method as claimed in claim 1, wherein the electro-optic waveguide core layer is formed by sputtering.

17. A method as claimed in in claim 1, wherein the step of forming the intermediate layer comprises sputtering.

18. A method as claimed in claim 1, wherein an average refractive index of the intermediate layer is less than an average refractive index of the core layer.

19. A method a claimed in claim 1, wherein the step of forming the intermediate layer comprises forming a zinc-oxide-based film on the substrate, the zinc-oxide-based film being sufficiently thick to optically isolate the core layer from the substrate.

20. A method as claimed in claim 1, wherein the step of forming the intermediate layer comprises forming a silica-based-film on the substrate and forming a zinc-oxide-based film on the silica-based film.

21. A method as claimed in claim 1, wherein the step of forming the intermediate layer comprises forming a film of platinum on the substrate and forming a PLZT film on the platinum film, the PLZT film being sufficiently thick to optically isolate the core layer from the platinum film.

22. A method as claimed in claim 1, wherein the intermediate and core layers are formed such that there is a graded refractive index transition from the intermediate layer to the core layer.

23. A method as claimed in claim 1 wherein the substrate includes an electrode layer.

24. An electro-optic waveguide structure comprising:
an intermediate layer formed on a substrate, and
a crystalline electro-optic waveguide core layer formed on the intermediate layer,
wherein the intermediate layer is arranged to promote the growth of a crystalline phase in the electro-optic waveguide core layer during fabrication of the waveguide structure, and, in use, to function as an optically-transmissive buffer layer for optically isolating the electro-optic waveguide core.

25. An optical waveguide structure as claimed in claim 24, wherein the intermediate layer comprises a layer of material having a structure arranged to promote the growth of a crystalline phase in the core layer during the fabrication of the waveguide, and wherein the intermediate layer has thickness which is sufficient to optically isolate the core layer from the substrate during use of the waveguide.

26. A waveguide structure as claimed in claim 24, wherein the intermediate layer comprises a seed layer formed on the substrate and a buffer layer formed on the seed layer, wherein the seed layer is arranged to promote the growth of a crystalline phase in the buffer layer during fabrication, and the buffer is arranged to promote the growth of a crystalline phase in the core layer during fabrication and to optically isolate the core layer during use.

27. A waveguide structure as claimed in claim 24, wherein the intermediate layer comprises an optically-transmissive buffer layer formed on the substrate and an optically-transmissive seed layer formed on the buffer layer, wherein the seed layer is arranged to promote the growth of the crystalline phase in the core layer during fabrication, and the buffer layer is arranged to optically isolate the core layer during use.

28. A waveguide structure as claimed in claim 24, wherein the substrate has a surface which is substantially amorphous.

29. A waveguide structure as claimed in claim 24, wherein the electro-optic waveguide core layer is polycrystalline with a preferred grain orientation.

30. An optical waveguide device incorporating a waveguide structure as defined in claim 24.

31. An optical waveguide device incorporating a waveguide structure as defined in claim 24, wherein the device is in the form of one or more of the following: of an optical modulator; an optical coupler for coupling an optical light signal between the electro-optic waveguide core layer and a further waveguide; a Mach-Zehnder interferometer.
